(19) United States
(12) Patent Application Publication
(10) Pub. No.: US 2002/0118672 A1
(43) Pub. Date: Aug. 29, 2002

(54) Concentrator

(76) Inventor: Yoshio Ikura, Fukuoka (JP)

Correspondence Address: RATNER AND PRESTIA, Suite 301, One Westlakes, Berwyn, P.O. Box 980, Valley Forge, PA, 19482-0980, US

(21) Appl. No.: 10/043,837

(22) Filed: Jan. 9, 2002

(30) Foreign Application Priority Data
Jan. 10, 2001 (JP) 2001-2199

(51) Int. Cl. H04L 12/66

(52) U.S. Cl. 370/352

(57) ABSTRACT

A concentrator which can be used for Internet telephone. A terminal is connected to a terminal interface. A line interface is connected to Internet by using a network such as a public line. A communication function unit controls the input/output of a voice signal in the terminal interface and the line interface, and of an Internet Protocol (IP) packet. A conversion unit converts the IP packet and the voice signal to each other. A memory stores the IP address of the concentrator. A connection establishing unit establishes the connection between a terminal and another terminal by allowing the communication function unit to transmit an IP datagram including the IP address of the concentrator to the network. A determining unit determines whether or not the terminal connected to the terminal interface is capable of the IP communication.

### FIELD OF THE INVENTION

The present invention relates to a concentrator, which enables smooth data communication, connecting a plurality of terminals to a network such as Internet via a communication line and preventing the band shortage of the communication line. Particularly, the present invention relates to a concentrator which transmits Internet Protocol (IP) packets for enabling the use of Internet telephone through a network such as a local area network (LAN) and Internet.

### BACKGROUND OF THE INVENTION

With the recent advance of technology for faster and upgraded computers and network equipment, not only data used in computers but also voice signals from telephones are transmitted in local area networks (LAN) and Internet.

In Internet telephone, voice signals from telephones are converted to IP packets and transmitted via Internet. Internet telephone is used in the following way: i) internet telephone is placed by connecting a computer provided with a voice output unit to Internet or ii) making a phone call from a standard telephone to a provider offering Internet telephone service in order to use the service.

Also, it has been unable to make smooth data communication or the like due to band shortage because the band of communication line is jointly used, and in order to solve such conventional problem, a network system using a concentrator is employed. The network system includes, for example, a LAN system such as Ethernet structurally based upon a system in which the terminals connected to the same LAN share the band of the communication line.

Herein, a concentrator stands for equipment as follows.

For example, assume that a plurality of terminals are connected to a network such as Internet through a communication line. In such a case the concentrator divides the communication line into predetermined groups by setting, and the communication line transmission is set to ON/OFFstate for each group. In this way, the concentrator allows each group to occupy the band every group and prevents lowering of the communication capacity due to band shortage.

An Internet telephone system using a conventional concentrator is described in the following with reference to the drawings.

FIG. 3 is a block diagram of an Internet telephone system using a conventional concentrator.

In FIG. 3, conventional concentrator 301 outputs the input voice signal or IP packet and the like, letting them pass through as it is. Computer 302 is connected to concentrator 301. Communication path 303 connects concentrator 301 to computer 302. Standard telephone 304 is connected to computer 302. Communication path 305 connects computer 302 to standard telephone 304. Network 306 is a network such as Internet capable of IP communication. Communication path 307 connects concentrator 301 to network 306. Computer 308 is connected to network 306. Communication path 309 connects computer 308 to network 306. Standard telephone 310 is connected to computer 308. Communication path 311 connects computer 308 to standard telephone 310.

As for an Internet telephone system using a conventional concentrator having a configuration as described above, the way of processing the signal, when a telephone call is made between standard telephone 304 and standard telephone 310, will be described with reference to FIG. 3. Standard telephones 304 and 310, as voice input/output devices, respectively transmit and receive the voice signal and the dial signal to and from the computers 302 and 308 connected via the communication paths 305 and 311.

Described in the following is the case of making a telephone call from standard telephone 304.

First, the IP address of computer 308 is dialed by standard telephone 304 connected to computer 302 via communication path 305. Or, the IP address of computer 308 is inputted to computer 302 by an input device (not shown) of a keyboard or the like connected to computer 302.

Computer 302 transmits IP datagram including the IP address of computer 302, as an IP packet, to computer 308 having the input IP address, via the communication path 303, concentrator 301, communication path 307, network 306, and communication path 309. Thus, computer 302 informs computer 308 of the intention of establishing communication by Internet telephone.

After computer 308 responds to the above signal directly or by standard telephone 310, the voice signal inputted to computer 302 from standard telephone 304 via communication path 305 will be processed as described below.

The voice signal is converted to an IP packet by computer 302 and transmitted to computer 308 via communication path 303, concentrator 301, communication path 307, network 306, and communication path 309.

The IP packet transmitted to computer 308 is converted to the voice signal by computer 308 and outputted to standard telephone 310 through communication path 311.

Also, the voice signal inputted to computer 308 by standard telephone 310 is processed in reverse order and outputted to standard telephone 304.

In this way, a telephone call is made between standard telephone 304 and standard telephone 310.

As described above, according to an Internet telephone system using conventional concentrator 301, when a telephone call is made, computer 302 designates IP address of computer 308. Next, a connection is established for making communication by Internet telephone possible between standard telephone 304 and standard telephone 310. After that, computer 302 and computer 308 respectively transmit and receive the IP packet to and from each other, thereby establishing the communication by Internet telephone. In that case, the concentrator 301, between the computer 302 and the network 306, outputs the IP packet input, allowing the IP packet to pass as it is.

However, an above conventional concentrator involves inconvenience as described in the following.

(1) When an Internet telephone call is made by using a standard telephone, the standard telephone serves as a voice input/output device for a computer. Accordingly, it is necessary to have an apparatus to connect the standard telephone to the computer. It will require labor and costs for purchasing and installing the apparatus.

(2) When an Internet telephone call is made by using a standard telephone, it is necessary to make registration or the like beforehand, for making Internet telephone by calling a provider with use of a public line. The procedure is complicated.

### SUMMARY OF THE INVENTION

The present invention addresses to the problems above discussed and aims to provide a concentrator which enables the use of Internet telephone by using a standard telephone.

The concentrator of the present invention has the following configuration. A terminal is connected to a terminal interface. A line interface is connected to Internet by using a network such as a public line. A communication function unit controls the input/output of voice signals and IP packets at the terminal interface and the line interface. Further, a conversion unit converts the IP packet and the voice signal to each other. A memory stores the IP address of the concentrator. A connection establishing unit allows the communication function unit to transmit the IP datagram including the IP address of the concentrator to the network to establish the connection between the terminal and another terminal connected to the network. Further, a determining unit determines whether or not the terminal connected to the terminal interface is capable of IP communication.

The concentrator requires no apparatus to connect a standard telephone to the computer. Also, using the concentrator, it is not needed for the user to make a phone call to a service provider.

### BRIEF DESCRIPTION OF THE DRAWINGS

FIG. 1 is a configuration diagram of a concentrator in the preferred embodiment 1 of the present invention.

FIG. 2 is a block diagram of an Internet telephone system using a concentrator in the preferred embodiment 1 of the present invention.

FIG. 3 is a block diagram of an Internet telephone system using a conventional concentrator.

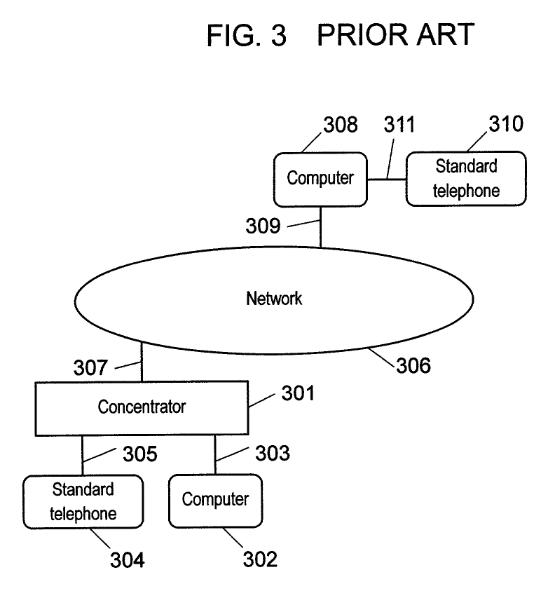

### DESCRIPTION OF THE PREFERRED EMBODIMENTS

The preferred embodiments of the present invention will be described in the following with reference to the drawings.

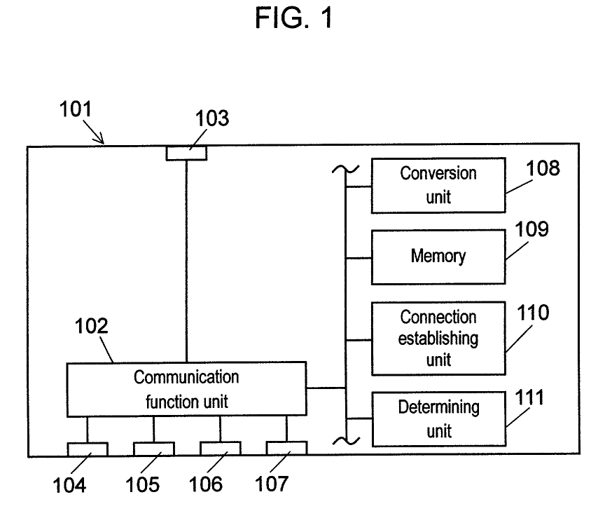

FIG. 1 shows the configuration of concentrator 101 in the preferred embodiment of the present invention.

Concentrator 101 includes communication function unit 102 and the following components.

Line interface 103 is connected with a public telephone line or the like which is connected to a network such as Internet. Terminal interfaces 104, 105, 106, 107 are connected with terminals such as standard telephones and computers. Conversion unit 108 converts voice signal and IP packet to each other. Memory 109 stores IP address of the concentrator 101. Connection establishing unit 110 establishes the connection to the intended terminal via a network such as Internet. Determining unit 111 individually determines whether or not the terminals connected to terminal interfaces 104, 105, 106, 107 are capable of IP communication. Bus 112 connects the communication function unit 102, conversion unit 108, memory 109, connection establishing unit 110, and determining unit 111.

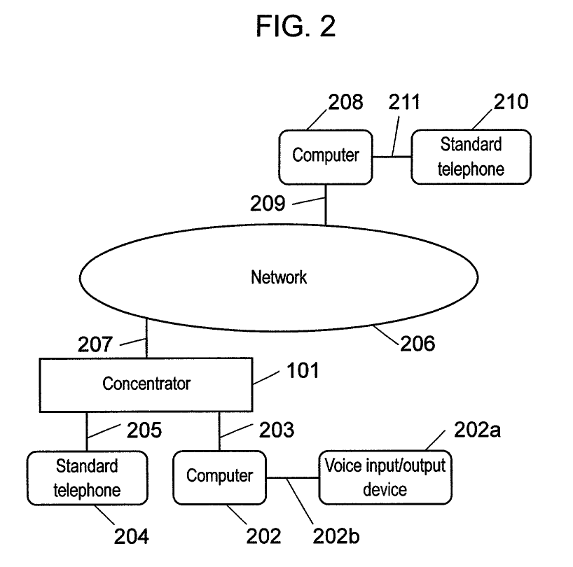

FIG. 2 is a block diagram of an Internet telephone system using a concentrator in an preferred embodiment of the present invention.

In FIG. 2, the concentrator 101 is identical with the one described in FIG. 1 and is provided with same reference numerals, omitting the description.

The Internet telephone system will be described in the following with reference to FIG. 2.

Computer 202 is connected to the concentrator 101. Voice input/output device 202a is connected to the computer 202, and transmits and receives voice signals for inputting and outputting the voice. Communication path 202b connects voice input/output device 202a to computer 202. Communication path 203 connects concentrator 101 to computer 202. Standard telephone 204 is connected to concentrator 101. Communication path 205 connects concentrator 101 to standard telephone 204.

Network 206 is a network such as Internet capable of Internet Protocol (IP) communication. Communication path 207 connects concentrator 101 to network 206. Communication path 208 is a computer connected to network 206, and communication path 209 connects computer 208 to network 206. Standard telephone 210 is connected to computer 208. Communication path 211 connects computer 208 to standard telephone 210.

Each of communication paths 203, 205 is connected to any one of terminal surfaces 104, 105, 106, 107 shown in FIG. 1. Communication path 209 is connected to line interface 103 shown in FIG. 1 via network 206.

In the present preferred embodiment, communication path 203 is connected to terminal interface 105, and communication path 205 is connected to terminal interface 104.

An Internet telephone system using a concentrator in the preferred embodiment of the present invention having a configuration as described above will be described with reference to FIG. 1 and FIG. 2.

In the present preferred embodiment, the standard telephone is at least supposed to have a function of transmitting IP address by using a dial signal format. This function can be, for example, realized by setting in the case of a telephone having DTMF dial function. Also, in the case of a telephone having only pulse dial function, IP address can be transmitted by using dial pulse by determining the interpretation of dial pulse between the concentrator and the telephone.

(1) Internet telephone communication between standard telephone 204 and standard telephone 210 via computer 208:

The processing for establishing Internet telephone communication between standard telephone 204 and standard telephone 210 via computer 208 is described in the following.

In place of standard telephone 210, it is also possible to use a voice input/output device which transmits and receives the voice signal to and from computer 208 connected via communication path 211.

When terminal interface 104 and standard telephone 204 are connected by communication path 205, determining unit 111 determines that the terminal connected to terminal interface 104 is not capable of IP communication.

Thereafter, connection establishing unit 110 establishes the connection to the terminal having the IP address based on the IP address having the dial signal format transmitted from the terminal connected to terminal interface 104.

Conversion unit 108 converts the voice signal, inputted to communication function unit 102 via terminal interface 104, to an IP packet and outputs it to line interface 103. Besides, conversion unit 108 converts the IP packet, inputted to communication function unit 102 via line interface 103, to the voice signal and outputs the voice signals to line interface 104.

First, the IP address of computer 208 is dialed by standard telephone 204. Thus, standard telephone 204 transmits the IP address of computer 208, in the dial signal format, to communication function unit 102 of concentrator 101 via the communication path 205 and terminal interface 104.

Subsequently, connection establishing unit 110 establishes the connection to computer 208 so that Internet telephone communication can be made between standard telephone 204 and computer 208 having the IP address input.

To achieve the purpose, connection establishing unit 110 instructs communication function unit 102 to transmit the IP datagram, as an IP packet, including the IP address of concentrator 101, stored in the memory 109, to the computer 208. Responsive to the instruction, communication function unit 102 transmits the IP packet to computer 208 via line interface 103, communication path 207, network 206, and communication path 209, thereby informing that the use of Internet telephone is intended. Then, since the IP packet includes the IP address of concentrator 101, computer 208 recognizes the use of Internet telephone through concentrator 101.

Next, computer 208 responds to the above signal directly or through standard telephone 210.

After that, the voice signal inputted to communication function unit 102 of concentrator 101 by standard telephone 204 via communication path 205 and terminal interface 104 is converted to an IP packet by conversion unit 108. Further, the IP packet is transmitted to computer 208 via line interface 103, communication path 207, network 206, and communication path 209.

The IP packet transmitted to the computer 208 is converted to the voice signal in computer 208 and outputted to standard telephone 210 via communication path 211.

Besides, the voice signal inputted to computer 208 from standard telephone 210 via communication path 211 is converted to an IP packet by computer 208. Thereafter, the IP packet is transmitted to the communication function unit 102 of the concentrator 101 via the communication path 209, network 206, communication path 207, line interface 103.

The IP packet transmitted to communication function unit 102 is converted to the voice signal by conversion unit 108 and outputted to standard telephone 204 via line interface 104 and communication path 205.

In this way, Internet telephone communication is performed between standard telephone 204 and standard telephone 210 via computer 208.

(2) Internet telephone communication between computer 202, and computer 208 and standard telephone 210:

Next, the processing for establishing Internet telephone communication between computer 202, and computer 208 and standard telephone 210 is described in the following.

When terminal interface 105 and standard telephone 202 are connected by communication path 203, determining unit 111 determines that the terminal connected to terminal interface 105 is capable of IP communication.

Thereafter, communication function unit 102 outputs the IP packet, inputted to communication function unit 102 from terminal interface 105, to line interface 103 as it is. Besides, communication function unit 102 outputs the IP packet, inputted to the communication function unit 102 from line interface 103, to terminal interface 105 as it is.

First, the IP address of computer 208 is inputted by an input device (not shown) such as a keyboard connected to computer 202. Computer 202 transmits the IP datagram as an IP packet including the IP address of computer 202 to computer 208 via communication path 203, concentrator 101, communication path 207, network 206, and communication path 209, thereby informing that the use of Internet telephone is intended.

Computer 208 responds to the above signal directly or through standard telephone 210. After that, the voice signal inputted from voice input/output device 202a via communication path 202b is converted to an IP packet by computer 202. The IP packet is transmitted to computer 208 via communication path 203, concentrator 101, communication path 207, network 206, and communication path 209.

The IP packet transmitted to computer 208 is converted to the voice signal by computer 208 and outputted to standard telephone 210 via communication path 211.

Also, the voice signal inputted to standard telephone 210 is outputted to voice input/output device 202a through the processing in reverse order.

In this way, Internet telephone communication is performed between computer 202, and computer 208 and standard telephone 210.

The configuration of concentrator 101 in the present preferred embodiment is as described above.

Concentrator 101 converts the voice signal and IP packet to and from each other by means of conversion unit 108. Further, in concentrator 101, memory 109 stores the IP address of the concentrator.

Connection establishing unit 110 establishes the connection with a terminal, with which a conversation is to be made, through network 206 such as Internet or the like.

Determining unit 111 determines whether or not the terminals connected to terminal interfaces 104, 105, 106, 107 are capable of communication. According to the result of determination, conversion unit 108 converts the voice signal and IP packet to each other. Accordingly, concentrator 101 directly connects standard telephone 204 to terminal interface 104, thereby enabling the use of Internet telephone.

In this way, when concentrator 101 is used, it requires no apparatus to connect standard telephone 204 to computer 202. Further, in that case, the user is able to make an Internet telephone call by using standard telephone 204 without calling a service provider.

In the present preferred embodiment, terminal interfaces 104, 105, 106, 107 are provided for concentrator 101, but the number of the interfaces provided is not limited to this number only. It is also possible to optionally select the number of terminal interfaces in accordance with the allowance of ability of communication function unit 102.

As described above, a concentrator of the present invention transmits and receives Internet Protocol (IP) packet to and from a network such as a public line, and thereby, it enables the use of Internet telephone by using a standard telephone.

What is claimed is:

1. A concentrator connected to a network, comprising:
(a) a terminal interface to which a terminal is connected;
(b) a line interface connected to said network;
(c) a communication function unit for controlling at least a voice signal and an IP packet input/output in said terminal interface and said line interface;
(d) a conversion unit for converting said IP packet and said voice signal to each other;
(e) a memory for storing an IP address of said concentrator; and
(f) a connection establishing unit for establishing a connection between said terminal and another terminal connected to said network, by allowing said communication function unit to transmit an IP datagram including the IP address of said concentrator to said network.

2. The concentrator of claim 1, further comprising:
a determining unit for determining whether or not said terminal connected to said terminal interface is capable of an IP communication, wherein
(i) when said determining unit determines that said terminal is capable of the IP communication, an IP packet input from said line interface is outputted to said terminal interface as it is, and an IP packet input from said terminal interface is outputted to said line interface as it is; and
(ii) when said determining unit determines that said terminal is not capable of the IP communication, the IP packet input from said line interface is converted to a voice signal by said conversion unit and outputted to said terminal interface, while a voice signal input from said terminal interface is converted to an IP packet and outputted to said line interface.

3. The concentrator of claim 2,
wherein when said terminal connected to said terminal interface is said standard telephone, it is determined that said terminal is not capable of IP communication.

4. The concentrator of claim 3,
wherein by receiving a dialing of the standard telephone as an IP address of a call destination, the connection to a terminal having the IP address of the call destination is established.

5. The concentrator of claim 4,
wherein when the connection is established, said concentrator transmits the IP datagram including the IP address of said concentrator to the terminal having the IP address of the call destination.

6. The concentrator of claim 2,
wherein when said terminal connected to said terminal interface is a computer, it is determined that said terminal is capable of an IP communication.

7. The concentrator of claim 6,
wherein said concentrator allows an IP datagram transmitted from said computer pass as it is, to a terminal having an IP address designated by said computer.

8. The concentrator of claim 7,
wherein when said computer establishes a connection, said concentrator transmits an IP datagram including an IP address of said computer to a terminal having IP address designated by said computer.
